(19) United States
(12) Patent Application Publication
(10) Pub. No.: US 2024/0300800 A1
(43) Pub. Date: Sep. 12, 2024

(54) Locating System

(71) Applicant: AS Strömungstechnik GmbH, Ostfildern (DE)

(72) Inventors: Andreas Szeteli, Filderstadt (DE); Nico Fischer, Stuttgart (DE)

(21) Appl. No.: 18/588,021

(22) Filed: Feb. 27, 2024

(30) Foreign Application Priority Data
Mar. 10, 2023 (EP) 23161101.3

(51) Int. Cl. B67D 1/08; G01S 19/13

(52) U.S. Cl. CPC B67D 1/0888; B67D 1/0802; G01S 19/13

(57) ABSTRACT

A locating system (15) for containers (3). The containers (3) each have at least one container opening (5) for supplying or dispensing storage medium. A container closure (14) designed for closing the container opening (5) is present for each container (3). A GPS tracker (10) designed for determining current location information of the container (3) is present in the container closure (14) or in a dip tube (4) opening out at the container closure (14). The current location information is transmitted to a cloud-based computer system (16) by means of the GPS tracker (10).

### CROSS REFERENCE TO RELATED APPLICATIONS

This application claims the priority of EP 23161101.3 filed on 2023-03-10; this application is incorporated by reference herein in its entirety.

### BACKGROUND

The invention relates to a locating system and a method for locating containers.

Such containers are generally used for storing storage media, particularly liquids. The container generally has a container opening via which the storage media can be dispensed from the container or supplied to it.

In particular, the containers can be part of a dispensing system.

Such a dispensing system is known from EP 0 977 702 B1. This dispensing system is used for filling and draining containers, particularly barrels, filled with liquid chemicals. The containers have, respectively, a dip tube via which liquids stored in the container can be dispensed and via which liquids can be supplied to the container. The dispensing system has a dispense head that is connected to the dip tube of the respective container.

Liquid is then dispensed from the container via the dispense head, or, as the case may be, supplied to it. For this purpose, a pump is connected via the dispense head in order to dispense or supply liquid.

Once the dispensing or supply of liquid is complete, the container opening of the respective container is closed with a closure means. The container is thus ready for transport. The container can then be transported to a use location where the liquid is required for conducting work processes, or to a storage location.

An essential problem in this context is effective object tracking, i.e., it should be possible to continuously locate the containers during their transport to control transport processes, to detect and correct incorrect dispatching of containers in a timely manner, and also to retrieve lost containers.

### SUMMARY

The invention relates to a locating system (15) for containers (3). The containers (3) each have at least one container opening (5) for supplying or dispensing storage medium. A container closure (14) designed for closing the container opening (5) is present for each container (3). A GPS tracker (10) designed for determining current location information of the container (3) is present in the container closure (14) or in a dip tube (4) opening out at the container closure (14). The current location information is transmitted to a cloud-based computer system (16) by means of the GPS tracker (10).

### DETAILED DESCRIPTION

The invention seeks to solve the problem of providing a simple and efficient locating system for containers of a dispensing system.

The features of the independent claims are provided to solve this problem. Advantageous embodiments and useful further developments of the invention are described in the dependent claims.

The invention relates to a locating system for containers. The containers each have at least one container opening for supplying or dispensing storage medium. A container closure designed for closing the container opening is present for each container. A GPS tracker designed for determining current location information of the container is present in the container closure or in a dip tube opening out at the container closure. The current location information is transmitted to a cloud-based computer system by means of the GPS tracker.

The container openings of the containers are closed with the one container closure and then constitute transportable units. In this context, each container can have multiple container openings, each of which can be closed with a container closure.

According to the invention, a GPS tracker that enables the container to be located is present in the container closure of each container. The GPS tracker is a radio navigation system that evaluates satellite information for determining a current location. The current location information thus determined by GPS (Global Positioning System) is transmitted by the GPS tracker to a cloud-based computer system.

The current location information of individual containers is stored and evaluated in the cloud-based computer system. The current location information is made available to a user via the cloud-based computer system.

The determination of the current location is time-dependent, such that a user can precisely track the respective container, particularly while it is being transported.

According to a first variant of the invention, the GPS tracker is integrated in a container closure with which the container opening of the respective container is closed. The GPS tracker is thus connected to the container such that it cannot be lost. It is especially advantageous in this context that the GPS tracker can be integrated in the container closure belonging to the container, i.e., it is not necessary to arrange any separate component on the container. On the one hand, this has the advantage that the design effort for integrating the GPS tracker in the container can be kept low, since the container closure is an already existing container component that can be used for this purpose.

A further advantage of integrating the GPS tracker in the container closure is that it makes unnecessary the use of separate components on the outside. Such external components can be easily damaged or even torn off during transport of the container. Such problems are prevented by the integration of the GPS tracker in the container closure.

A high degree of security against tampering is achieved by integrating the GPS tracker in the container closure, since unauthorized access to the GPS tracker is not possible and due to the fixed assignment of the container closure, a fixed assignment of the GPS tracker to the container is given.

Using a tamper-evident seal to secure the connection of the container closure to the container is especially advantageous. It is then only possible to remove the container closure by destroying the tamper-evident seal.

According to an advantageous embodiment of the invention, the containers are part of a dispensing system.

In this case, it is typical for a dip tube opening out at the container opening to be present in each container. At its opening-out at the container opening, the dip tube can be sealed off with a dip tube closure constituting a container closure.

The GPS tracker can then be integrated in the dip tube according to the second variant of the invention.

The dispensing system has a dispense head that can be connected to the container opening of a container. Via the dispense head, storage medium can be dispensed from the container or supplied to it.

The storage medium is then typically constituted by a liquid.

According to an advantageous embodiment, the GPS tracker is arranged in an encapsulation in the container closure.

Advantageously, the encapsulation is liquid-tight and gas-tight, such that the GPS tracker is protected inside the encapsulation, in particular from any contact with the storage medium in the container.

Corrosive, hazardous chemicals may be stored in the respective container. Storage medium in the form of liquids, in particular, is stored in the containers.

Such liquids may be constituted, in particular, by chemicals that are required to carry out work processes, in particular in the semi-conductor industry.

The encapsulation of the sensor unit prevents the chemicals stored in the container from attacking and damaging the components of the sensor unit.

Advantageously, a SIM card is assigned to the GPS tracker for access to a mobile communication network. Additionally a battery can be assigned to the GPS tracker for providing an autonomous energy supply. These components are arranged in the encapsulation with the GPS tracker, such that these form a compact assembly which is protected as a whole in the encapsulation from external influences. An inductive charging device from charging the battery can also be present in the encapsulation.

According to an advantageous further development of the invention, a temperature sensor, a fill-level sensor and/or a sensor for detecting shocks are arranged in the encapsulation.

Advantageously, current location information is transmitted over the internet.

In this context, it is expedient to transmit the current location information over a mobile communication network, wherein the access to the mobile communication network is enabled by the SIM card assigned to a GPS tracker.

According to an advantageous embodiment, an identifier of the respective container is transmitted with the current location information. A current location information of a container is stored in the cloud-based computer system along with the identifier of the container.

A locating based on the current location information, which has been detected in a time-dependent manner, takes place in the cloud-based computer system for the individual containers labeled with identifiers.

The identifier can uniquely label the respective container.

Information contained in the identifier and which identifies a container can be the article, serial or order number of a container.

Furthermore, the storage medium present in the container can be identified by means of the identifier.

The identifier can contain the specifications of the storage medium stored in the container, in particular, liquids.

Advantageously, the identifier can be stored in an RFID chip that is present in the container closure. Instead of an RFID chip, an NFC reader can also be used for reading stored identifiers.

Advantageously, current location information stored in the cloud-based computer system about containers can be called up by means of a user unit.

A user can call up current location information about containers at any time by means of the user unit, and thus track their current location in a time-dependent manner. The user unit is generally constituted by a computer unit. For example, the user unit can be constituted by a PC, a laptop or a mobile end device, such as a smartphone.

Advantageously, an app via which the access to the cloud-based computer system is enabled is present in the user unit. In this context, access codes can be used to preset whether the user gets access to all containers stored in the cloud-based computer system or only to a subset thereof. The user can uniquely identify these based on the identifiers stored with the current location information.

### BRIEF DESCRIPTION OF THE DRAWINGS

The invention is explained in the following with reference to the drawings. They show:

FIG. 1: A schematic illustration of a dispensing system with an assigned container.

FIG. 2: Dip tube of the container according to FIG. 1 with an assigned dip tube closure.

FIG. 3: Depiction of a container with a container closure.

FIG. 4: Block wiring diagram of the locating system according to the invention.

### DETAILED DESCRIPTION OF THE PREFERRED EMBODIMENTS

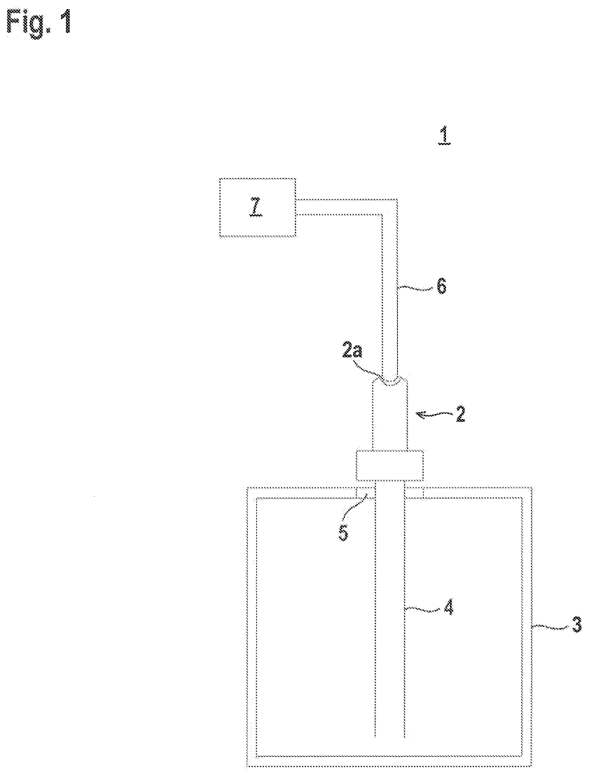

FIG. 1 shows a dispensing system 1 in schematic form. The dispensing system 1 comprises a dispense head 2 that can be attached to a container 3 which can be designed particularly in the shape of a barrel. A liquid is stored in the container 3. Liquids stored in such containers 3 are in particular liquid specialty chemicals.

The container 3 has a dip tube 4. The dip tube 4 is mounted in a bung head, which sits in a container opening 5 of the container 3 and is thus securely connected to the container 3. The longitudinal axis of the dip tube 4 runs in the vertical direction.

The dispense head 2 is used for dispensing liquids from the container 3. The dispense head 2 can also be used for filling containers 3. For this purpose, the dispense head 2 has a liquid connection 2a at its upper end. A line 6 that leads to a pump 7 is connected to this connection for liquids 2a. The line 6 can be constituted in the form of a hose.

The pump 7 is controlled by a control unit (not shown).

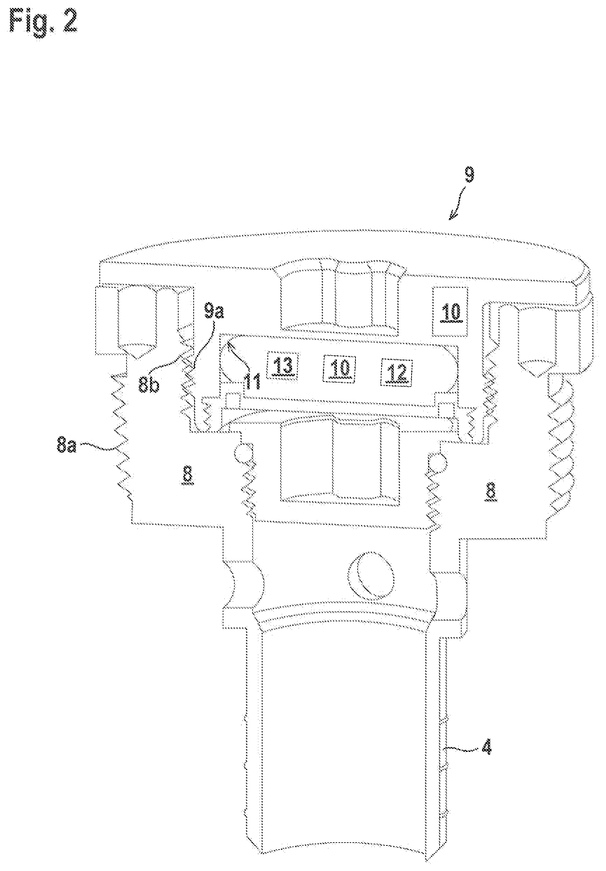

In an enlarged partial depiction, FIG. 2 shows the upper region of the dip tube 4, which at its upper end has a head part 8 that is mounted in the container opening 5. In the present case, the head part 8 is screwed into the container opening 5. The head part 8 has an outer thread 9a for this purpose.

The opening at the upper end of the dip tube 4 can be closed with a dip tube closure 9. In the present case, the dip tube closure 9 is screwed securely to the dip tube 4. For this purpose, the dip tube closure 9 has an outer thread 9a and the head part 8 has a corresponding inner thread 8b. The container 3 closed with the dip tube closure 9 forms a transportable unit.

A GPS tracker 10 is arranged in the dip tube closure 9. The GPS tracker 10 is found in an encapsulation 11 which, preferably, is gas-tight and liquid-tight. The encapsulation 11 also constitutes explosion protection. A SIM card 12 and a battery 13 are arranged in the encapsulation 11 with the GPS tracker 10. An inductive charging unit can be assigned to the battery 13.

Alternatively, this arrangement can be arranged in the dip tube 4, in particular in the head part 8. According to an advantageous further development, a temperature sensor, a fill-level sensor and/or a sensor for detecting shocks are arranged in the encapsulation 11.

The GPS tracker 10 is a radio navigation system that determines the actual current location of the dip tube closure 9, and thus of the container 3, based on satellite information. The SIM card 12 allows for a connection to a mobile communication network. The battery 13 is a simple energy supply for the GPS tracker 10 with the SIM card 12.

Furthermore, an RFID chip (not shown) is arranged in the dip tube closure 9. At least one identifier that uniquely identifies the container 3 and/or the storage medium stored in the container 3 is stored in the RFID chip.

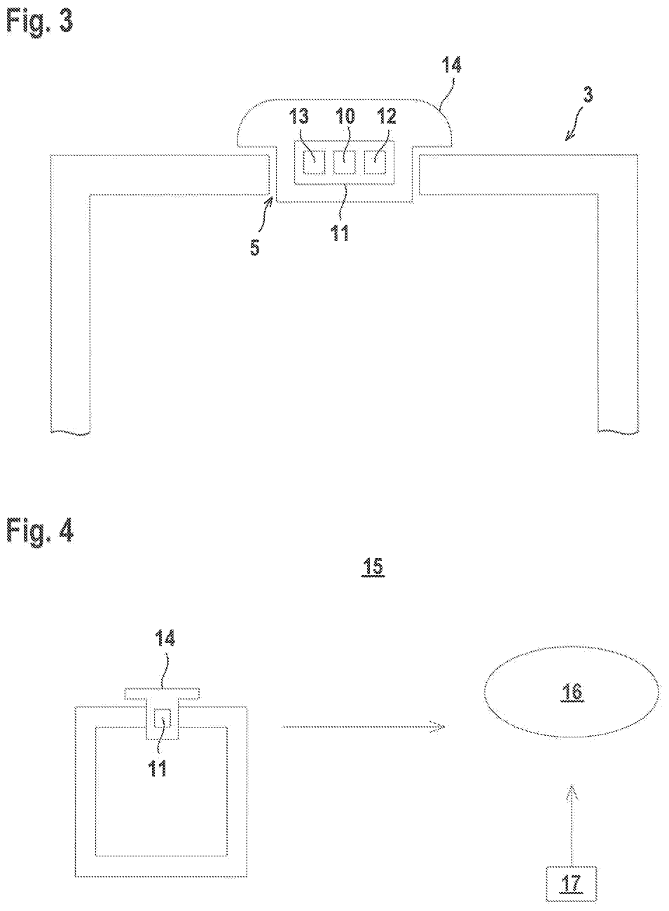

FIG. 3 shows an embodiment of a container 3 in which no dip tube 4 is present. The container opening 5 of the container 3 is closed with a container closure 14. Again, an encapsulation 11 in which the GPS tracker 10, the SIM card 12 and the battery 13 are integrated is present in the container closure 14. In this case as well, an RFID chip (not shown) in which is stored at least one identifier that uniquely identifies the container 3, and/or the storage medium stored in the container 3, is present in the container closure 14.

FIG. 4 shows an exemplary embodiment of the locating system 15 according to the invention in which the container 3 is provided according to FIG. 3. Of course, the locating system 15 can also be realized with the container 3 of the dispensing system 1 from FIGS. 1 and 2.

The GPS tracker 10 transmits actually determined current location information together with the identifier read from the RFID chip over the internet to a cloud, i.e., a cloud-based computer system 16. It is expedient for the data to be transmitted over a mobile communication network.

The GPS trackers 10 of the containers 3 transmit their actual current location information together with the identifier of the respective container 3 to the cloud-based computer system 16.

The current location information, with the identifiers, is stored and, as the case may be, evaluated, in the cloud-based computing system 16. In general, the locating system 15 can comprise multiple containers 3, in the container closure 14 of each of which a GPS tracker 10 is present.

The actual current location information for all containers 3 is then stored in the cloud-based computer system 16 under the respective identifiers. The current location information can be uniquely associated with the respective containers 3 through the identifiers. The current locations of the containers 3 are detected in a time-dependent manner with the GPS trackers 10. Thus based on the current location information for each container 3, its current location can be tracked in a time-dependent manner.

With a user unit 17, a user can call up current location information of containers 3 from the cloud-based computer system 16 and thereby track the current locations of the containers 3 in a time-dependent manner. The user unit 17 is generally a computer unit that can be constituted by a PC, a laptop, a smartphone or similar. Advantageously, an app via which the access to the cloud-based computer system 16 is enabled is present in the user unit 17. In this context, access codes can be used to preset whether the user gets access to all containers 3 stored in the cloud-based computer system 16 or only to a subset thereof.

### LIST OF REFERENCE NUMERALS

(1) dispensing system
(2) dispense head
(3) container
(4) dip tube
(5) container opening
(6) line
(7) pump
(8) head part
(9) dip tube closure
(9a) external thread
(10) GPS tracker
(11) encapsulation
(12) SIM card
(13) battery
(14) container closure
(15) locating system
(16) cloud-based computer system
(17) user unit

1. A locating system (15) for containers (3), wherein the containers (3) each have at least one container opening (5) for supplying or dispensing storage medium, characterized in that a container closure (14) designed for closing the container opening (5) is present for each container (3), and in that a GPS tracker (10) is present in the container closure (14) or in a dip tube (4) opening out at the container closure (14), the GPS tracker (10) being designed for determining current location information of the container (3), and in that the current location information is transmitted to a cloud-based computer system (16) by means of the GPS tracker (10).

2. The locating system (15) according to claim 1, characterized in that the GPS tracker (10) is arranged in an encapsulation (11) of the container closure (14).

3. The locating system (15) according to claim 1, characterized in that a SIM card (12) and a battery (13) are assigned to the GPS tracker (10).

4. The locating system (15) according to claim 3, characterized in that an inductive charging unit is assigned to the battery (13).

5. The locating system (15) according to claim 2, characterized in that the SIM card (12) and the battery (13) and the inductive charging unit are arranged in the encapsulation (11).

6. The locating system (15) according to claim 2, characterized in that a temperature sensor, a fill-level sensor and/or a sensor for detecting shocks are arranged in the encapsulation (11).

7. The locating system (15) according to claim 1, characterized in that storage medium in the form of liquids is stored in the containers (3).

8. The locating system (15) according to claim 1, characterized in that the containers (3) are part of a dispensing system (1).

9. The locating system (15) according to claim 1, characterized in that the dip tube (4) can be closed off where it opens out at the container opening (5) with a dip tube closure (9) forming a container closure (14).

10. The locating system (15) according to claim 1, characterized in that the dispensing system (1) has a dispense head (2) that can be connected to the container opening (5) of a container (3), wherein via the dispense head (2) storage medium can be dispensed from the container or supplied to it.

11. The locating system (15) according to claim 1, characterized in that an identifier of the respective container (3) is transmitted with the current location information of a container (3), wherein a current location information of a container (3) is stored in the cloud-based computer system (16) together with the identifier of the container (3).

12. The locating system (15) according to claim 11, characterized in that the respective container (3) can be identified by means of the identifier.

13. The locating system (15) according to claim 11, characterized in that the storage medium present in the container (3) can be identified by means of the identifier.

14. The locating system (15) according to claim 1, characterized in that the current location information can be transmitted via the internet.

15. The locating system (15) according to claim 1, characterized in that the current location information can be transmitted via a mobile communication network.

16. The locating system (15) according to claim 1, characterized in that current location information of containers (3) stored in the cloud-based computer system (16) can be called up by means of a user unit (17).

17. The locating system (15) according to claim 16, characterized in that the end device is a mobile end device.

18. A method for operating a locating system (15) for containers (3), wherein the containers (3) each have at least one container opening (5) for supplying or dispensing storage medium, characterized in that a container closure (14) designed for closing the container opening (5) is present for each container (3), and in that a GPS tracker (10) is present in the container closure (14) or in a dip tube (4) opening out at the container closure (14), the GPS tracker (10) being designed for determining current location information of the container (3), and in that the current location information is transmitted to a cloud-based computer system (16) by means of the GPS tracker (10).
